(19) United States
(12) Patent Application Publication
(10) Pub. No.: US 2008/0263619 A1
(43) Pub. Date: Oct. 23, 2008

(54) Display of Enhanced Content

(76) Inventor: Johannes Cornelis Leonardus Auwens, Oisterwijk (NL)

Correspondence Address: HARRINGTON & SMITH, PC, 4 RESEARCH DRIVE, SHELTON, CT, 06484-6212, US

(21) Appl. No.: 11/597,735

(22) PCT Filed: May 20, 2005
(86) PCT No.: PCT/IB05/01596

§ 371 Date: Jun. 13, 2008

(30) Foreign Application Priority Data
May 25, 2004 (GB) 0411682.8

(51) Int. Cl. H04N 7/173

(52) U.S. Cl. 725/134

(57) ABSTRACT

A decoder for use in an interactive television system in which items of enhanced content can be presented to users, the decoder: including a receiver for receiving enhanced content data, a signal including timing indications and a video stream; a memory for storing enhanced content data received by the receiver and a timing schedule indicating timings associated with the enhanced content data; a timer; playout means for presenting the video data to a user, and being responsive to the timer for presenting the enhanced content data stored in the memory to a user in accordance with the state of the timer and the timing schedule; and synchronising means for synchronising the timer in accordance with the received timing indications.

### FIELD OF THE INVENTION

This invention relates to interactive television systems, and in particular to the display of enhanced content in interactive television systems.

### BACKGROUND OF THE INVENTION

A prior art interactive television system is shown generally in FIG. 1. The system includes a digital video data provider 1, decoders 3a-c for converting the digital video data to an analogue format, a television 5 at each decoder for displaying the video data, and enhanced content transmitted over a network 2. In current systems, the enhanced content is transmitted to decoders such as set-top boxes (STBs), which then display pages of enhanced content on a television. A user input device 4 is provided at each decoder 3a-c so that a user can adjust settings of the decoder and/or the television 5 and respond to queries or questions in the enhanced content. The user input device 4 could, for example, be a keypad or remote control.

The enhanced content is typically content available to be displayed at the direct or indirect request of a user onto a television screen. The enhanced content is typically in addition to the basic audio-visual (A/V) data of a television program or movie. It may consist of information, such as news, television schedules, or weather reports, or may invite a response from a user.

Enhanced content may be transmitted over a network independently of A/V data, or alternatively may be embedded in the A/V data.

The term “interactive television” suggests that a viewer can provide input to the system, for example to respond to queries within the enhanced content or to control the video stream that he receives. An example of a user input/response is an answer to a question posed in the enhanced content (or interactive content). If the video content being displayed on a television is, for example, a quiz show, it may be desirable to provide interactive content consisting of quiz questions corresponding to those being asked in the quiz show.

FIG. 2 shows in more detail the decoding arrangement of a prior art interactive television system. A network 2 provides decoder 3 with a stream of enhanced content 8, together with an indication of the required flow of that content. The flow will normally be indicated by reference to a video stream that that enhanced content accompanies. The enhanced content 8 is inputted to a formatting unit 9 for formatting its input signal into a series of pages 10a-d of enhanced content for display on television 5.

Each page 10a-d could have associated with it a time at which it is to be displayed on the television. In this implementation, referring to the example shown in FIG. 2, the pages 10a-d are associated with a television program which commences at 16.30. The first page, 10a, is to be displayed at 16.31. The second page, 10b is to be displayed at 16.32, and 10c and 10d are to be displayed at 16.38 and 16.40 respectively.

To control the play-out of the enhanced content an internal clock or timer 39 can be provided at the decoder (which will typically be a set top box (STB)). The clock can be set to zero at the start of a particular event, such as a show, represented by the video stream received at the decoder.

In order that the decoder can cause the enhanced content associated with a particular show to be displayed on a television at the desired time, it is necessary for the decoder to be provided with details of the required timings for the display of the enhanced content. A schedule of timing information, indicating the required timings, will typically be transmitted to and stored at the decoder, and then accessed to determine appropriate playout times for the associated enhanced content. The schedule of timing information will typically indicate timings relative to the start of the show with which the enhanced content is associated. The start of the show will generally be denoted as “time zero”, and subsequent timings of enhanced content display will be measured relative to zero. For example, an item of enhanced content may be associated with the timing information 293, indicating that that item is to be played out 293 seconds after time zero.

When the decoder determines that a new show has commenced, the internal clock will be set to zero and when the time on the clock reaches a time identified in the timing schedule as an enhanced content play out time, the appropriate page of enhanced content will be displayed on a television. Control information can be sent to the decoder. The control information is typically sent over the same physical link as the A/V data, and can be embedded in the A/V data or sent over a different data channel on that link. Typically the control information is of a predetermined format that allows messages of various types to be sent to the decoder. The messages may include a message indicating that a new show has started, and in response to receiving such a message the decoder can reset to zero the timer/clock that it uses for the play-out of enhanced content.

This arrangement has a number of disadvantages. Firstly, the broadcast schedule must be known by the provider of enhanced content in advance of the transmission of the stream of enhanced content 8. In this way, the time at which each page of enhanced content is to be displayed can be embedded into the stream 8 before transmission. In addition to the enhanced content provider requiring information regarding the start time of each television program for which it is providing enhanced content, it also needs information on the timing of any scheduled intermissions, such as advertising breaks, in each program.

Secondly, this arrangement for the display of enhanced content is incapable of making adjustments to accommodate changes to the advertised broadcast schedule. Similarly, the arrangement cannot accommodate unadvertised intermissions in the broadcast. These could occur if the broadcast has to be interrupted for some reason. Also, if the broadcast is to be interrupted by advertisements the position and duration of the advertising breaks must be taken into account when the enhanced content is set up. If the broadcast is to be shown on a number of channels which have different advertising schedules then the enhanced content must be set up for each one. If the timings are not set up correctly then enhanced content can be played out at the wrong time relative to the A/V data, and for one program may continue to be displayed after that program has been interrupted. Problems due to poor synchronisation are especially acute in applications where relatively close synchronisation of the video and the enhanced content are required: for example during a quiz show when the enhanced content is to give users an opportunity to interactively answer a question posed by a quiz show host shown in the video.

It is desirable that there should be an improved way in which the display of enhanced content is synchronised with a video or other signal to which it is related.

### STATEMENT OF THE INVENTION

According to a first aspect of the present invention there is provided a decoder for use in an interactive television system in which items of enhanced content can be presented to users, the decoder comprising: a receiver for receiving enhanced content data, a signal comprising timing indications and a video stream; a memory for storing enhanced content data received by the receiver and a timing schedule indicating timings associated with the enhanced content data; a timer; playout means for presenting the video data to a user, and being responsive to the timer for presenting the enhanced content data stored in the memory to a user in accordance with the state of the timer and the timing schedule; and synchronising means for synchronising the timer in accordance with the received timing indications. The signal comprising timing indications may further comprise indications of the identity of an event represented by the video stream.

The playout means may be further arranged to determine an identity of the enhanced content and determine from the signal the identity of an event, and subsequently determine whether the enhanced content identity matches the identity of the event.

The decoder may be responsive to receipt at the receiver of a signal comprising timing indications to begin presenting the enhanced content data.

The playout means may be responsive to the state of the timer and the timing schedule for presenting enhanced content data such that when the timer denotes a time indicated in the timing schedule, the playout means presents enhanced content.

The timing schedule may comprise indications of the identity of items of enhanced content represented by the enhanced content data, and the playout means is responsive to the timing schedule such that an item of enhanced content is presented at a timing indicated in the timing schedule as being associated with that item.

According to a second aspect of the present invention there is provided a method of presenting items of enhanced content to a user comprising the steps of: receiving enhanced content data, a signal comprising timing indications and a video stream; storing the received enhanced content data and a timing schedule indicating timings associated with the enhanced content data; presenting the video data to the user; synchronising a timer in accordance with the received timing indications; and responsive to the timer, presenting the stored enhanced content data to the user in accordance with the state of the timer and the timing schedule.

### BRIEF DESCRIPTION OF THE DRAWINGS

The present invention will now be described in more detail by way of example with reference to the accompanying drawings in which:

FIG. 1 shows a prior art interactive television system;

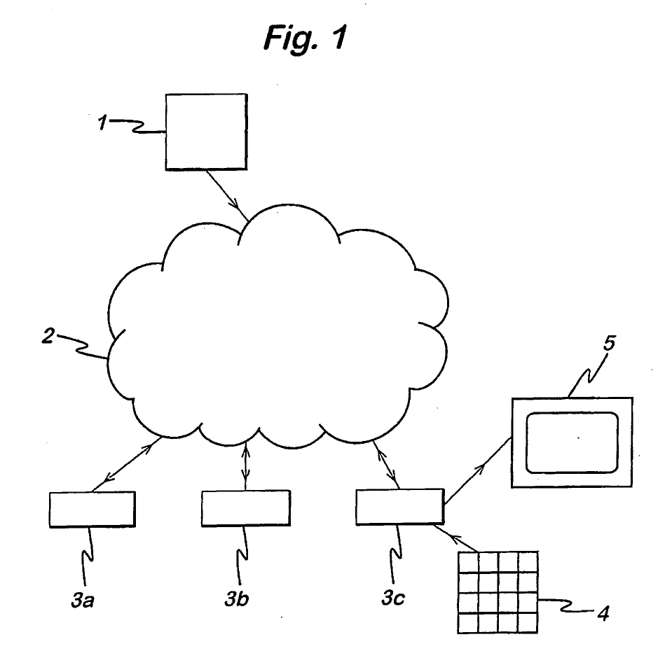

FIG. 2 shows in more detail the decoding arrangement of a prior art interactive television system;

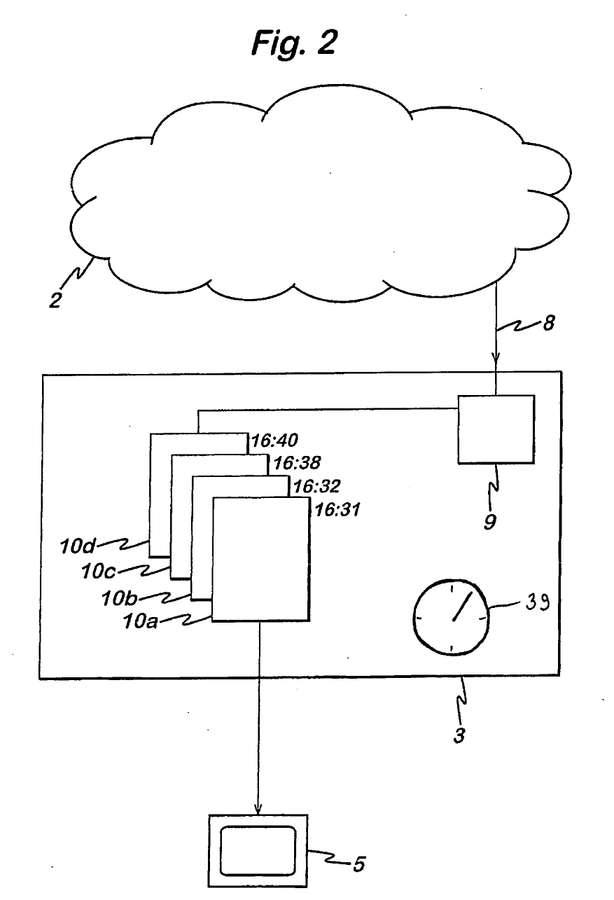

FIG. 3 shows a system for providing and decoding a video stream including enhanced content; and

FIG. 4 shows an interactive television network.

### DETAILED DESCRIPTION

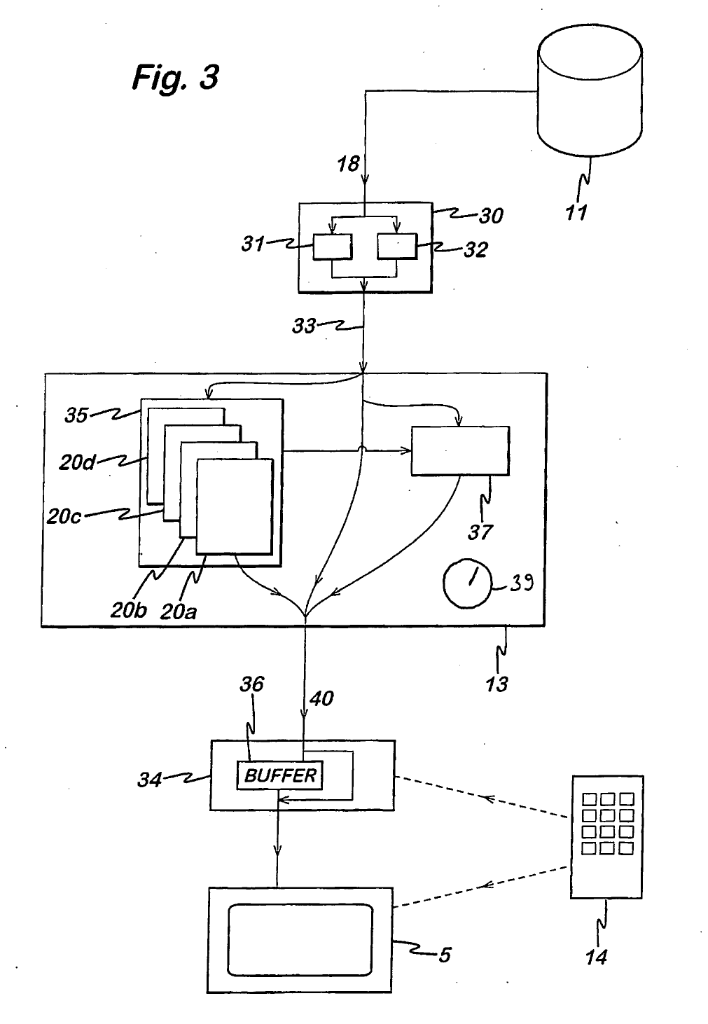

An exemplary embodiment of the present invention will be described with reference to FIG. 3. In the system of FIG. 3, a combined data stream is prepared by a content provider 11. This data stream comprises a running program of video data, together with items of enhanced content associated with that video data. The enhanced content can suitably be embedded within the stream of video data.

The content provider 11 also defines a synchronisation schedule which indicates the points relative to the running of the video stream at which each of the items of enhanced content is to be presented (played out) to a user. The synchronisation schedule suitably relates the presentation of some or all of the items of enhanced content to a corresponding time relative to the video stream.

In this embodiment, codes are embedded periodically into the video stream, and the codes allow the time within a video stream representing a particular show to be determined. Each code includes a timing field which indicates the time offset between the start of the stream and the point in the stream at which that code is embedded. The synchronisation schedule indicates the time as indicated by the embedded codes at which enhanced content is to be presented. Some of the items of enhanced content could be accessed on demand by a user (for instance by means of hyperlinks from another item of enhanced content) or when a trigger is sent in real time from a producer of the program. These items would not need to have times stored for them.

The codes may also indicate the identity of the program currently carried by the video stream, in which case the decoder can identify the start of a program from a change in the indicated program identity. Alternatively, a change in program could be signalled by a specific message that is embedded in the video stream or carried to the decoder over a separate channel.

The codes, messages, enhanced content and other control data could be sent over the same data channel as the AN data, or over a different channel. They could be sent over the same physical link as the AN data, or over a different link.

The content provider 11 transmits the enhanced content, the video stream and the synchronisation schedule over link 18 to a playout management centre (PMC) 30. At the playout management centre certain changes are made to the data to adapt them for successfully being played out over the distribution system of which the playout management centre is a part. In an enhanced content adaptation unit 31 the enhanced content is adapted if necessary so that it can be decoded by the types of decoders (e.g. set-top boxes) that are used in the system. In a video adaptation unit 32 UCC (unified content code) messages are inserted at regular intervals in the video stream. Preferably UCC messages are inserted into the video stream at intervals of one second, or more frequently.

Each UCC message suitably consists of a 15-digit code according to the following layout:

| | Pos: | | | | | | | | | | | | | | |
|---|---|---|---|---|---|---|---|---|---|---|---|---|---|---|---|
| | 15 | 14 | 13 | 12 | 11 | 10 | 9 | 8 | 7 | 6 | 5 | 4 | 3 | 2 | 1 |
| Name: | R | R | R | C | C | C | C | P | P | P | P | P | P | P | CS |

R: a 3-digit region number conforming to ISO 3166-1
C: a 4-digit company number
P: a 7-digit product number
CS: a 1-digit checksum number conforming to ISO/IEC 15420 Annex A

The UCC codes indicate the identity of a program by means of the R, C and P numbers.

Each UCC also includes a timestamp that indicates the timing of that UCC relative to the start of the video stream.

The transformed enhanced content, video stream and synchronisation schedule are transmitted over a link 33 to a media control manager (MCM) 13. The overall distribution system may comprise two or more MCMs, each serving different geographical areas and/or types of decoder.

A number of decoders such as set-top box 34 or digital televisions are connected to the distribution unit 13. Each decoder is capable of decoding received items of enhanced content and video stream and causing them to be presented to a user via presentation means such as television 5. A controller 14 is also available to a user, whereby the user can indicate to the decoder which channel he wishes to receive.

The use of periodic codes or messages embedded within a data stream as discussed above is known in the art of enhanced television (eTV).

In some previously-known systems, prior to the time when a presentation is to be played out to users, the enhanced content for the presentation and preferably also the synchronisation schedule for the presentation are transmitted by the playout management centre (PMC) 30 to the Media Control Manager (MCM) 13. At the MCM the synchronisation schedule is stored and the enhanced content can be buffered, if necessary, in buffer 35. Subsequently, the enhanced content is transmitted by the MCM to the decoders that it serves, for instance set-top box (STB) 34, and buffered there, e.g. in buffer 36. Typically, all the enhanced content for the presentation is transmitted to the decoders before the presentation begins, but the enhanced content could be transmitted to the decoders in stages. In such systems, the decoders can store the enhanced content, but are arranged not to present it until triggered to do so by a trigger signal from the MCM.

When the time comes for the presentation to be played out, the video stream is transmitted to the MCM 13 and distributed from there to the decoders. As the video stream is transferred through the MCM a traffic analyser analyses the UCC codes in the video stream and the timing stream of the video stream.

In prior systems, the traffic analyser monitors the UCC codes as they are received. Whilst UCC codes indicating the identity of the presentation are being received in the video stream the trigger generator is enabled to generate trigger signals for sending to the decoders in respect of the enhanced content of that presentation. If the traffic analyser determines that such UCC codes are no longer being received, for example because no such UCC code has been detected for a predetermined period, then it is disabled for generating trigger signals for sending to the decoders in respect of the enhanced content of that presentation. When the traffic analyser determines that such UCC codes are no longer being received, the trigger generator may also transmit a signal to the decoders to cause them to disable the play-out of the enhanced content of that presentation.

While the trigger generator is enabled for sending trigger signals in respect of the enhanced content of the presentation the traffic analyser monitors the timing stream of the video stream of the presentation and compares the current value of the timing stream with the timings indicated in the synchronisation schedule. The MCM maintains a clock that is synchronised to the timestamps contained in the UCCs. In prior systems, when the current value of the clock matches a timing indicated in the synchronisation schedule for an item of enhanced data, and the trigger generator is enabled for generating trigger signals, the trigger generator sends a trigger signal to the decoders to trigger the play out of that item of enhanced content.

When the video stream is resumed after a break, the trigger generator determines from the synchronisation schedule whether an item of enhanced content should be being presented at the point at which the video stream has resumed. If so, it triggers the decoders to present that item.

In this way, if the video stream of the presentation is interrupted, for example by a commercial break, the playout of the enhanced content of the presentation will also be interrupted since the UCCs of the presentation will stop being received. When the video stream is resumed the UCCs of the presentation will restart and the enhanced content will be resumed.

The decoders are arranged to be responsive to the trigger and halt signals to cause enhanced content to be presented or to halt presentation of enhanced content respectively.

Generally, in prior systems the video stream, the enhanced content and the trigger signals are sent to each decoder only in accordance with the channel selection of the decoder's user. Also, a user may select not to have enhanced content presented to him from time to time, for example by configuring his set-top box accordingly.

The presentation of items of enhanced content may also be triggered in prior systems by their being called by a user using a hyperlink from another item of enhanced content; or by the transmission to the decoders, via the MCM, of an ad hoc trigger signal from a controller at the PMC.

Prior systems such as that described above have the advantage that the timing of enhanced content playout can be controlled accurately to ensure that the playout of a particular item of enhanced content occurs at the time in a running program where it is intended—for example, during a quiz show at a time when a question is asked to the audience, and viewers are to be given the opportunity of responding via an eTV application. In addition, such systems can take into account unadvertised breaks in a show or situations where an TV schedule becomes incorrect due to an event such as a live sports match running over the anticipated time slot and continuing into the next advertised time slot. In cases such as these, any enhanced content associated with TV shows can still be played out at the correct times in the shows because the enhanced content playout is triggered by the MCM determining that a particular time from the start of a TV show has been reached. In other words, triggering occurs relative to the start of a show rather than at absolute times based on an advertised TV schedule.

However, in these prior systems, if a trigger signal sent from an MCM is not received at a decoder, or is in some way degraded or lost as it is transmitted to a decoder, the enhanced content item to which that trigger signal relates may not be played out. Therefore there may be situations or conditions (such as poor transmission due to adverse atmospheric effects) in which such prior systems fail to present all items of enhanced content to a user as intended.

Embodiments of the present invention allow accurately synchronised playout of enhanced content in television systems. Instead of distribution units providing trigger signals to decoders, the triggering is instead provided within a decoder such as an STB. In this way, there is no need for a trigger signal to be transmitted across the distance between a distribution unit and a decoder. Activation signals are transmitted to decoders, and if there is any loss or deterioration of these signals between the distribution unit and the decoders, the decoders can nevertheless still cause enhanced content to be played out to a user owing to the running of the internal clock 39, which causes pages of enhanced content to be displayed on a display unit at appropriate times as indicated in a timing schedule associated with the enhanced content by means of internal triggering within the decoder. If a particular activation signal is transmitted from a distribution unit but not received at a decoder, then the effect will preferably be only that the clock 39 is not synchronised with the timecode in the activation signal at the time when the activation signal should have been received, as discussed further below. In other respects, the system will function as normal and the playout of pages of enhanced content will be triggered within the decoder according to the clock and the timing schedule.

The internal clock 39 could be a digital timer operating in hardware or software, with a precision of, for instance, 1 second or less. The internal clock maintains a count of the time elapsed since the start of a program. To accommodate delays in the starting of the program the clock is started by the decoder in response to it detecting the start of the program, for example by the means described above. To accommodate interruptions in the program, the clock could be stopped during the interruption. The interruption could be detected, for example from the identity of the program as currently indicated in the UCC codes being received by the decoder. On resumption of the program, as indicated by the UCC codes, the timer can be restarted.

In embodiments of the present invention, the internal clock within a decoder is regularly synchronised with the timing codes received from a distribution unit. The timing codes could suitably be provided by UCCs as described above, or by any other timing stream embedded within a running program or transmitted to the decoder in some way such that it can be associated with a running program. Thus, the timing codes could be carried over the same physical link as the video data or a different link, and over the same data channel as the video data or a different link. In one suitable arrangement, the timing codes could be carried in a logical control channel embedded in the video data. Messages of various types can be carried over the logical control channel, each message being of a predetermined format that includes a message type field indicating the type of the message. One type of message can be a timing code message, which can carry data representing the time (e.g. the time in seconds) since the start of the current program. Attentively, the timing codes could be sent over a dedicated timing code channel, in which case no type field would be needed. The timing codes could represent absolute times or offset times relative to an arbitrary zero. Zero could, for example, represent the start of a show. On receiving a timing code the decoder promptly adjusts its timer to match the time indicated in the timing code. Preferably, a distribution unit such as an MCM 13 has an traffic analyser for detecting and interpreting UCCs. Preferably, UCCs embedded within a running program are transmitted to decoders together with the running program. Upon detection of a UCC indicating the start of a new show, the MCM begins to transmit an activation signal to a decoder. This activation signal suitably comprises an identifier indicating the show to which it relates and a corresponding UCC timecode. Activation signals are preferably sent regularly, for example every x seconds, where x is suitably 0.5, 1 or 2. The activation signals are preferably transmitted by the MCM for as long as UCCs relating to the same show (i.e. program) are received at the MCM, and when a new show then commences (as indicated by UCCs embedded in a running program), a series of activation signals relating to that new show will be transmitted. Preferably, halt signals are transmitted at the start of a break in a show, such as a scheduled advertisement break or an unscheduled break caused by an event such as an unanticipated news flash, so that enhanced content playout occurs only during the intended show. Thus, an MCM can be arranged to pause transmission of activation signals when UCCs are not being detected at a traffic analyser of the MCM.

When an activation signal is received at the decoder, the decoder resynchronises its internal clock 39 to the timecode in the activation signal. This ensures the continuing accuracy of the timing of the playout of enhanced content items triggered by the decoder.

The activation signals can also be used by the decoder to check that the show to which an item of enhanced content relates is the show indicated by the activation signal. In this way, it is possible to ensure that enhanced content will be played out together with the appropriate show.

The activation signals could be transmitted to decoders in the ways described above with reference to timing codes, e.g. as part of an out-of-band signal or alternatively as part of an inband signal. On receipt of an activation signal relating to a set of items of enhanced content, the enhanced content being associated with a particular show, a decoder triggers the playout of the enhanced content on a display unit such as a television at the times indicated in the timing schedule as being the times when the items are to be played out to users. A trigger is a signal which causes the decoder to execute a particular action, typically the execution of a script. The script could, for example, be for loading a new enhanced content page onto a screen, increasing the value of a number displayed on the screen (such as a score), or changing a line of text displayed on the screen.

Optionally, an internal timer 39 in the decoder is started when the decoder receives an activation signal indicating a new show. The timer will then continue to run for the duration of the show, and will preferably be paused during advertisement breaks or other scheduled or non-scheduled intermissions in the show, and re-started when the show re-starts. Each time the timer approaches a time indicated in the timing schedule for enhanced content playout, a trigger will be initiated in the decoder to cause the appropriate item of enhanced content to be presented to a viewer at the time indicated in the timing schedule.

The enhanced content could include video and/or audio data or (if used with a suitable unit for presenting the data to a user) other forms of data. The enhanced content could be defined as pages or clips of information, or in other ways.

In a specific example, the decoder receives some or all of the enhanced content data for a program and stores it in a local cache. The enhanced content data includes a number of items of enhanced content, and a timing schedule comprising a timing indicator for each item of enhanced content. Each item of enhanced content is associated with a timing indicator which indicates the time after the start of the program at which that item of enhanced content is to be played out. The decoder receives an A/V stream which includes data representing the program. The A/V stream is played out to a user, for example by providing a feed to the user's television. The decoder could detect the start of the program in question, and in response to that it could reset its timer to zero. However, a preferred arrangement would involve an MCM detecting the start of the program (using the UCC mechanism) and transmitting a message to decoders to indicate that their timers should be reset to zero. The message could be transmitted within an activation signal. The decoder's timer then runs, counting the time since the start of the program. When the decoder detects that the program has been interrupted the timer is paused, and when it detects that the program has been resumed the timer is resumed. The decoder compares the state of the timer with the stored timing indicators. When the timer matches a timing indicator the item of enhanced content that corresponds to that timing indicator is played out. When the decoder receives a timing indication message it adjusts the timer (if necessary) to synchronise the timer with that timing indication.

The timing indication is suitably an indication of the time since the start of the program, allowing the timer to be straightforwardly synchronised with it. Other forms of indication are also possible.

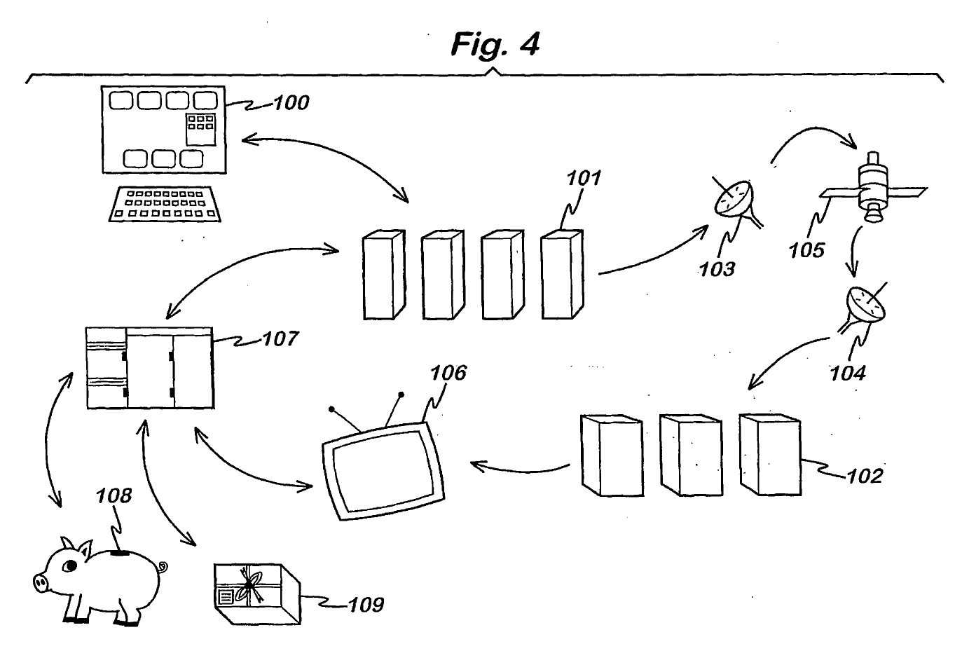

FIG. 4 shows an example of a broadcast network in which the present system may be employed.

The network shown in FIG. 4 comprises an Edit Suite 100, a Playout Management Centre 101, a Media Control Manager 102, uplink and downlink stations 103 and 104, a satellite 105, a decoder 106, and a Transaction Management System 107. The decoder 106 may, for example, be a set-top box or a digital television. Each of the components of the system will be described in turn. The components can communicate with each other as indicated by the arrows in FIG. 4.

Interactive content is produced at the Edit Suite 100 (specifically, in a Content Production Manager (CPM)) on generic re-usable templates. The general templates can be manipulated by designers to produce a template with the desired format for a particular application. This specific template can then be saved to the memory of the CPM. Subsequent data can be added easily and quickly to the application-specific template, for example, daily news, weather or TV guides.

Once data has been added to a template at a CPM, the populated template is inputted to an Event Broker Console (EBC), the second stage of an Edit Suite, where it has a stream script added to it.

Meta-data (the UCCs and timestamps described above) is then added to the main broadcast stream (i.e. the video stream) that is associated with the content of the template. The meta-data allows the stream script to be triggered in real-time to synchronise the content with the main broadcast stream. For live television events, the EBC can be used to manage the broadcast of interactive pages, as will be described later.

Following production at the Edit Suite, the template data is passed to a Playout Management Centre (PMC) 101, which converts the data to a signal (representing pages of interactive content) in the relevant format for any platform on which it is to be received and displayed. The PMC can store the interactive content until it is needed. Once the interactive content is required, it is transmitted to a Media Control Manager (MCM) 102. To reach the MCM the interactive content could be sent to an uplink station 103 and transmitted via a satellite 105 to a downlink station 104 or could be sent in another way, for instance by cable.

The MCM 102 is located in a cable TV digital head end. The MCM receives interactive data from a PMC 101, stores it until it is to be played out, and, in response to receiving a trigger, broadcasts it to decoders 106. The decoders could be set-top boxes connected to televisions, or they could be digital televisions.

The MCM can be informed in a number of ways of when to cause a page of interactive content to be played out, by being transmitted from the MCM to the decoder 106, and subsequently displayed. For example, if the television event to which the interactive content is related is being broadcast live, then an editor at an Edit Suite 100 can manually trigger the play-out of the content from the MCMs 102 to ensure that the content is synchronised with an appropriate part of the television event. In the case of a live event, meta-data is not added to the content, but instead an engineer could directly control the sending of the (de)activation signal and the triggers according to the images from the main broadcast stream, the activation and deactivation signal respectively initiate and terminate the broadcasting of the enhancements, the triggers are used to trigger the display of the required page.

Alternatively, triggers can be arranged to be sent automatically at pre-determined times during a television event. In this case, the decoder has access to a time schedule and on the basis of this schedule, sends triggers to decoders at the times when it is desired for the interactive content to be played out. For instance, a TV programme might start at 7.30 pm, and triggers could then be sent automatically from the MCM 102 at 7.31 pm, 7.35 pm, 7.42 pm and so on, depending on the parts of the programme with which each page of interactive content is related. As another alternative, markers could be embedded in the video signal associated with a particular set of interactive pages, and triggers could be generated in dependence on the association between the markers and the pages. These markers would be the meta-data referred to above which is added to the video stream.

The MCM 102 can also manage the bandwidth allocated to video signals and interactive content signals according to television events taking place. Content can also be stored/buffered at the MCM.

A Transaction Management System (TMS) 107 is employed to deal with responses of subscribers to the interactive content broadcast. The TMS is capable of handling large numbers of concurrent responses, and can produce, for example, lists of winners of a competition following the subscriber responses. The TMS is linked to the PMC so that information related to subscriber responses can be fed back and inserted into broadcasts from the MCM 102. In addition, the PMC can communicate with the TMS.

For handling payments to action user responses the TMS is linked to a banking system 108. The TMS may send signals to other functions such as a third party fulfilment centre 109 so as to action user responses, for example to fulfil purchases or issue prizes.

Editors at the Edit Suites 100 can communicate with the TMS 107 via PMC 101 in order to determine how the TMS should react to responses sent from subscribers.

In a system as described above with reference to FIG. 4, there would typically be multiple Edit Suites 100, one PMC 101, multiple MCMs 102 distributed geographically across an area served by the network, and one TMS 107, although in future it may be desirable in terms of efficiency to provide multiple PMCs and/or TMSs. Decoders 106 would be positioned locally to individual viewers, for example in their homes or in public buildings.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A decoder for use in an interactive television system in which items of enhanced content can be presented to users, the decoder comprising:
a receiver for receiving enhanced content data, a signal comprising timing indications and a video stream;
a memory for storing enhanced content data received by the receiver and a timing schedule indicating timings associated with the enhanced content data;
a timer;
playout means for presenting the video data to a user, and being responsive to the timer for presenting the enhanced content data stored in the memory to a user in accordance with the state of the timer and the timing schedule; and
synchronising means for synchronising the timer in accordance with the received timing indications.

2. A decoder according to claim 1 wherein the signal comprising timing indications further comprises indications of the identity of an event represented by the video stream.

3. A decoder according to claim 2 wherein the playout means is further arranged to determine an identity of the enhanced content and determine from the signal the identity of an event, and subsequently determine whether the enhanced content identity matches the identity of the event.

4. A decoder according to claim 1 wherein the decoder is responsive to receipt at the receiver of a signal comprising timing indications to begin presenting the enhanced content data.

5. A decoder according to claim 1 wherein the playout means is responsive to the state of the timer and the timing schedule for presenting enhanced content data such that when the timer denotes a time indicated in the timing schedule, the playout means presents enhanced content.

6. A decoder according to claim 1 wherein the timing schedule comprises indications of the identity of items of enhanced content represented by the enhanced content data, and the playout means is responsive to the timing schedule such that an item of enhanced content is presented at a timing indicated in the timing schedule as being associated with that item.

7. A method of presenting items of enhanced content to a user comprising the steps of:
receiving enhanced content data, a signal comprising timing indications and a video stream;
storing the received enhanced content data and a timing schedule indicating timings associated with the enhanced content data;
presenting the video data to the user;
synchronising a timer in accordance with the received timing indications; and
responsive to the timer, presenting the stored enhanced content data to the user in accordance with the state of the timer and the timing schedule.

8. A method according to claim 7 wherein the signal comprising timing indications further comprises indications of the identity of an event represented by the video stream.

9. A method according to claim 8 further comprising the steps of:
determining an identity of the enhanced content;
determining from the signal the identity of an event; and subsequently:
determining whether the enhanced content identity matches the identity of the event.

10. A method according to claim 7 wherein the step of presenting the stored enhanced content occurs in response to the step of receiving a signal comprising timing indications.

11. A method according to claim 7 wherein the presentation of the stored enhanced content data is responsive to the timer such that when the timer denotes a time indicated in the timing schedule, presentation of the stored enhanced content data occurs.

12. A method according to claim 7 wherein the timing schedule comprises indications of the identity of items of enhanced content represented by the enhanced content data, and the presentation of the stored enhanced content data is responsive to the timing schedule such that presentation of an item of enhanced content occurs at a timing indicated in the timing schedule as being associated with that item.
